(19) United States
(12) Patent Application Publication
(10) Pub. No.: US 2004/0254968 A1
(43) Pub. Date: Dec. 16, 2004

(54) Interpolation for waveform and vector displays

(76) Inventor: Kevin M. Ferguson, Beaverton, OR (US)

Correspondence Address: TEKTRONIX, INC., Francis I. Gray, MS 50-LAW, P.O. Box 500, Beaverton, OR, 97077, US

(21) Appl. No.: 10/463,154

(22) Filed: Jun. 16, 2003

(51) Int. Cl. G06F 7/38

(52) U.S. Cl. 708/290

(57) ABSTRACT

A method of interpolating data for a waveform or vector display provides a variable interpolation rate based upon a distance between consecutive samples of input data. The distance is used to access a coefficient look-up table from among a plurality of coefficient look-up tables, the number of look-up tables being a function of the number of interpolation rates desired. The distance is also used to control a clock for reading out the coefficients from the coefficient look-up table. The distance is variable between consecutive samples. A finite impulse response (FIR) filter receives the coefficients from the coefficient look-up table and provides interpolated data between each set of consecutive samples. The distance may also be used to control the intensity of an electronic beam for a display device upon which the interpolated data is displayed.

### BACKGROUND OF THE INVENTION

The present invention relates to signal measurements, and more particularly to a method of interpolating between sampled points for waveform and vector displays.

For video monitoring displays such as waveform, vector, Arrowhead, Diamond, Spearhead, etc. a plot of the amplitude of one parameter, such as luminance, a color difference channel, etc., versus another, such as time, another color difference channel, etc., is rendered. For digitally sampled data such as digital video (ITU-R BT.601) and for streaming video such as .avi, etc., it is desired to interpolate between sampled points for both input parameters for several reasons. One reason is to allow traditional test signals, such as color bars, to be rendered in a familiar and recognizable way to detect abnormalities in the signal. Without interpolation subtle changes in the transitions may be hard to detect, as shown in FIG. 1.

Interpolation has been done in the past primarily in three ways:

(1) Statistically/pseudo-random sample intervals;

(2) Constant up-sample rate with representative reconstruction filter; and

(3) Dynamic up-sample rate with linear interpolation.

The first method depends on (a) constantly changing the sampling phase when sampling an analog signal input and (b) the periodicity of the signal, filling in between previous sample points with each new period. This method does not work if the sampling phase cannot be changed, such as 601 serial digital or .asf/.avi video, or if the signal is not periodic.

The second method requires a great deal of computation, thus being expensive or impractical in many cases. For example in order to interpolate between two points on a Diamond display which represents maximum excursion in both red and green input channels, up-sample rates for state-of-the-art displays need to be at least 100:1. This requires a sustained processing rate of 100 times the original video rate. Yet inputs typically have a low duty cycle of maximum excursions and a higher percentage of small changes from sample to sample. Thus most of the processing is wasted on interpolating 100 points between two points that are close or coincident.

The third method only interpolates the points between the original sample points by using a dynamic up-sample rate. However the prior art only uses linear interpolation which does not reflect the reconstructed analog waveform and is, therefore, misleading and not useful in many monitoring, test and diagnostic applications. An example of the linear interpolation follows:

Linear Interpolation @ Variable Sample Rates:

(Uses equation of a line: y=mx+b where m=slope and b=y intercept)

Example:

point 1: (1, 13)=(x₀, y₀)

point 2: (4, 38)=(x₁, y₁)

m=slope=(y₁−y₀)/(x₁−x₀)=(38−13)/(4−1)=25/3=8.333

b=yintercept=y₀−m*x₀=13−(8.333)*1=4.667

now for interpolating between x₀ and x₁, y may be calculated. Likewise all points between y₀ and y₁ may be filled in by using f⁻¹ (y)=x=(y−b)/m.

What is desired is a computationally simple, but dynamic, method of interpolation between sample points that is more accurate, better looking and an improved match to traditional analog displays.

### BRIEF SUMMARY OF THE INVENTION

Accordingly the present invention provides a method of interpolating between sample points of input data for waveform and vector displays using a variable interpolation rate based upon a distance between the consecutive samples. The distance is used to access a coefficient look-up table from among a plurality of coefficient look-up tables, the number of coefficient look-up tables being a function of the number of interpolation rates desired. The distance is also used to control a clock for reading out the coefficients from the coefficient look-up table. The distance is variable between consecutive samples. A finite impulse response (FIR) filter receives the coefficients from the coefficient look-up table and provides interpolated data between each set of consecutive samples. The distance may also be used to control the intensity of an electronic beam for a display device upon which the interpolated data is displayed.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a screen view of an Arrowhead display for a color bar test signal without interpolation.

FIG. 2 is a block diagram view of a fast dynamic rate interpolating filter according to the present invention.

FIG. 3 is a graphic view showing symmetry of an example chrominance filter response according to the present invention.

FIG. 4 is a graphic view showing even symmetry of the example filter response of FIG. 3 rendered without a look-up table according to the present invention.

FIG. 5 is a graphic view showing an example interpolation of a straight line using a look-up table to obtain coefficients for a four-tap FIR interpolation filter according to the present invention.

FIG. 6 is a graphic view of a vertical zoom for FIG. 5 according to the present invention.

FIG. 7 is a graphic view of a frequency response for the interpolation filter according to the present invention.

FIG. 8 is a screen view of an Arrowhead display for a color bar test signal with interpolation according to the present invention.

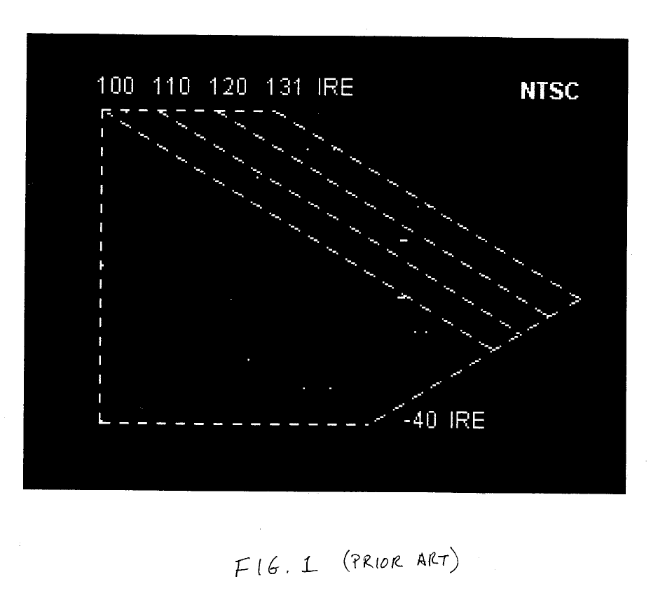

### DETAILED DESCRIPTION OF THE INVENTION

Referring now to FIG. 2 as an example, a four-tap FIR reconstruction filter based on a dynamic up-sample rate interpolator is used for lowpass filtering and interpolating signals for producing an Arrowhead display as shown in FIG. 8. X or Y channel data is input to an interpolation distance determiner 12 and the first of a series of sample delay lines 14-20. The output of each delay line 14-20 is input to a corresponding multiplier 22-28, the outputs of which in turn are input to a summer 30. Also the output of the first n-1 delay lines 14-18 is input to the next delay line in sequence. This forms a conventional FIR filter. The coefficients for the multipliers 22-28 are contained in a look-up table (LUT) 32 which contains a separate coefficient look-up table for each of various sample rates.

The interpolation distance determiner 12 is used to access the LUT 32 to determine which coefficient look-up table to use for the FIR filter. The interpolation distance determiner 12 also provides an output to simulate beam current control, or intensity, and provides an input to an index/clock control module 34 which clocks the coefficients for the FIR filter from the selected coefficient look-up table. The result is that the output from the summer 30 is the interpolated data for the input channel.

The interpolation distance determiner 12 establishes an up-sample rate required. Since X-Y plots require ordered pairs (x,y), both channels require the same up-sample rate which is the greater of the two independently calculated distances. For full bandwidth reconstruction filters the absolute difference of samples before and after the interpolated signal may be used. For example, for a luminance waveform display (luminance amplitude versus time) where y(t)=42 and y(t+1)=57, the distance is simply 57−42=15 and the up-sample rate is 15 for both the luminance and time samples. For band-limited signals the absolute difference of adjacent samples is included in the maximum difference calculation: y(t−2)=110, y(t−1)=100, y(t)=42 and y(t+1)=57 and maximum distance=100−42=58. The distance also may be used to modulate intensity. For example, intensity=K1/(K2+distance) where K1=2 and K2=1.

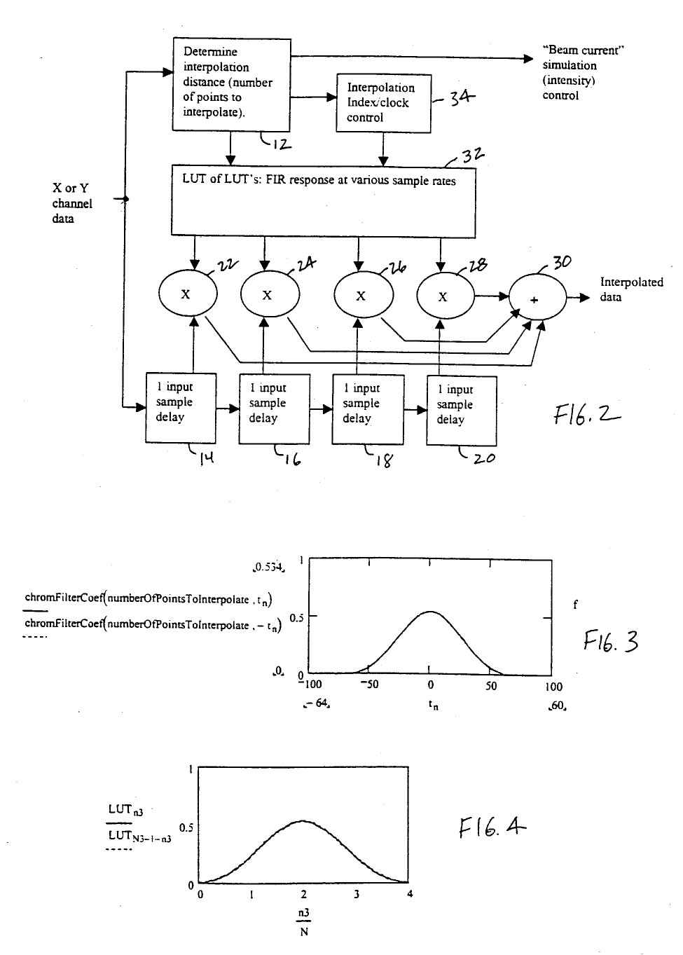

Filter coefficients at each up-sample rate (integer multiples—15 and 58 in the above examples) are precalculated and each loaded into one of the look-up tables of the LUT 32. For the four-tap filter shown at a ×15 up-sample rate, the four coefficients representing the desired filter impulse response at the original sample rate are up-sampled to 15×4=60 points representing the filter response within the time window, illustrated in FIGS. 3-6. As usual the specific values of the coefficients depend on the particular bandwidth, filter response shape, sample rate, etc. required.

FIG. 3 shows an exemplary chrominance filter response defined by the coefficients

chromFilterCoef(numberOfPointsTolnterpolate, tₙ)

which is symmetrical and therefore equal to

chromFilterCoef(numberOfPointsTolnterpolate, −tₙ)

This response is rendered in a look-up table as represented in FIG. 4 as

LUTₙ₃:=chromFilterCoef[N, (n3−offset+0.5)

The interpolated data is then computed as

interp2ₙ₃:=Σₜₐₚ chromFilterCoef[N, n3−N*(tap)]*dataₜₐₚ

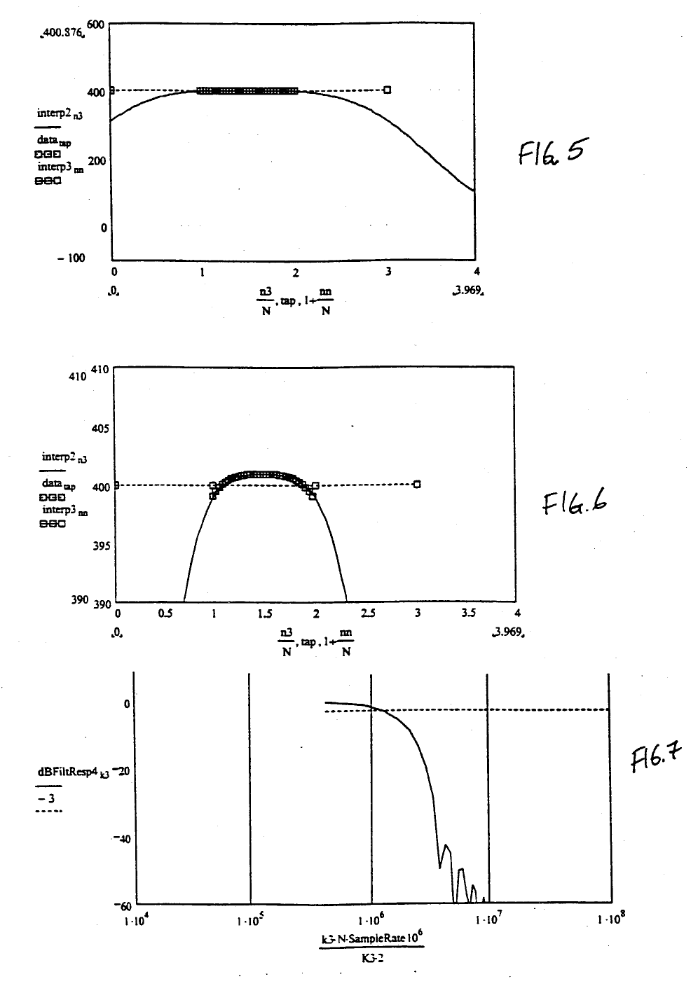

FIGS. 5-6 illustrate the interpolation of a straight line using LUTₙ₃ for the coefficients, with FIG. 6 being a vertical zoom of FIG. 5.

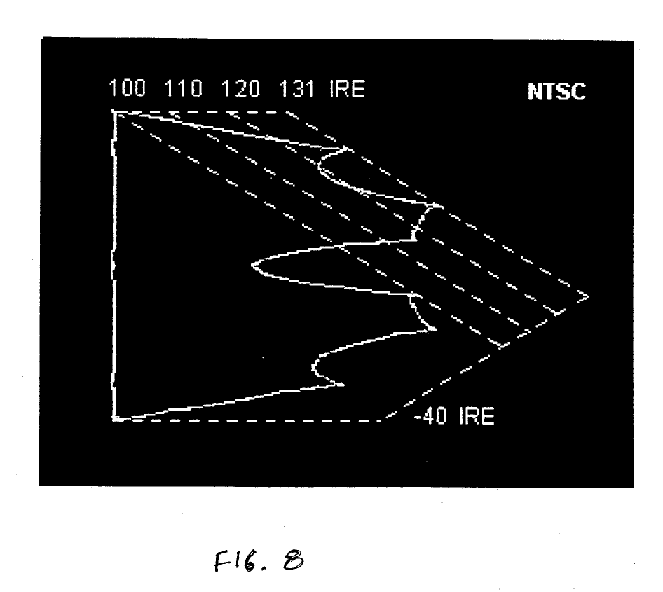

The equivalent interpolation filter response dBFiltResp4ₖ₃ is represented in FIG. 7 so that the resulting Arrowhead display for a color bars digital video signal is as shown in FIG. 8, which is a good match to a corresponding traditional analog display.

The described interpolation filter is practical for software implementations in a general purpose central processor unit (CPU) or computer. Interpolation may be automatically suspended if too complex, i.e., CPU cycles are not available. This approach is somewhat self-mitigating: very complex displays generally benefit less from interpolation whereas relatively few transitions in a display may be much more useful with interpolation.

In the prior art no look-up tables were used, but the inaccuracy of linear interpolation is not acceptable. The combination here of accuracy and speed (efficiency) is achieved via the look-up table of look-up tables. Although a video signal display is used as an example of the interpolation described above, such interpolation may be applied to any digital data where an analog-style display is desired.

Thus the present invention provides improved accuracy and speed of interpolation for waveform and vector displays by using a look-up table of look-up tables, each look-up table containing filter coefficients for each variable rate anticipated.

What is claimed is:

1. A method of interpolating between consecutive samples of input data comprising the steps of:
determining an interpolation distance from the consecutive samples;
accessing a look-up table from among a plurality of look-up tables according to the interpolation distance;
filtering the consecutive samples according to coefficients from the look-up table to provide interpolated data between the consecutive samples; and
repeating the determining, accessing and filtering steps for each set of consecutive samples of the input data.

2. The method as recited in claim 1 further comprising the step of providing a beam intensity value for a display device as a function of the interpolation distance.

3. A method of adaptive interpolating between consecutive samples of input data comprising the steps of:
determining for each set of consecutive samples an interpolation rate; and
filtering between each set of consecutive samples as a function of the interpolation rate to produce interpolated data.
